(19) United States
(12) Patent Application Publication
(10) Pub. No.: US 2020/0117438 A1
(43) Pub. Date: Apr. 16, 2020

(54) SCHEDULING SIMPLIFICATION VIA GEOFENCE TIME ZONE RESOLUTION

(71) Applicant: FORD GLOBAL TECHNOLOGIES, LLC, Dearborn, MI (US)

(72) Inventors: Brian WITHUN, Livonia, MI (US); Brian David TILLMAN, Dearborn, MI (US); Stephanie GAGE, Northville, MI (US); Mohamad NASSER, Dearborn Heights, MI (US)

(21) Appl. No.: 16/156,330

(22) Filed: Oct. 10, 2018

(51) Int. Cl. G06F 8/65; G06F 17/30

(52) U.S. Cl. CPC G06F 8/65; G06F 17/30241

(57) ABSTRACT

A boundary of a geofence spanning a plurality of time zones is received by a vehicle. A primary time zone of the geofence is identified. Installation of a software update is initiated responsive to the vehicle being located within the geofence and a current time within the primary time zone being within a period of time for software updates.

### TECHNICAL FIELD

Aspects of the disclosure generally relate to resolving geofences to a single time zone to simplify scheduling of vehicle operations such as software updates.

### BACKGROUND

Modern vehicles include components operated by controllers that execute software. From time to time, the software may require to be updated. Over-the-air (OTA) software updating has become increasingly popular for the convenience it provides. In an OTA system, vehicles are instructed to download the new software wirelessly “over the air” from a server. These software updates to the vehicles may be scheduled when the vehicles are expected to be parked and not in use. For example, a user may elect to have software updates installed at night time when the user is asleep.

### SUMMARY

In one or more illustrative examples, a system includes a processor of a vehicle programmed to initiate installation of a software update to the vehicle responsive to the vehicle being located within a geofence and a current time being within a period of time for software updates, the current time being determined as a primary time zone of the geofence, not of a current location of the vehicle.

In one or more illustrative examples, a method includes receiving, by a vehicle, a boundary of a geofence spanning a plurality of time zones; identifying a primary time zone of the geofence; and initiating installation of a software update responsive to the vehicle being located within the geofence and a current time within the primary time zone being within a period of time for software updates.

In one or more illustrative examples, a non-transitory computer-readable medium comprising instructions that, when executed by a processor of a gateway of a vehicle, causes the gateway to receive a boundary of a geofence spanning a plurality of time zones; identify a primary time zone of the geofence; and initiate installation of a software update responsive to the vehicle being located within the geofence and a current time within the primary time zone being within a period of time for software updates.

### BRIEF DESCRIPTION OF THE DRAWINGS

FIG. 1 illustrates an example system including geofences for use in triggering OTA installation of software updates;

FIG. 2 illustrates an example diagram of a geofence that includes area within multiple time zones; and

FIG. 3 illustrates an example process for assigning a geofence to a single time zone; and

FIG. 4 illustrates an example process for using a geofence to trigger OTA installation of a software update.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A user may define a geofenced area in which unattended OTA vehicle updates may occur. In some cases, this geofenced area may overlap multiple time zones. Responsive to the vehicle being located within the geofenced area, the OTA update may be performed. However, it may be possible for a vehicle to move between different time zones while staying inside the geofence boundary for the OTA update. In such a case, it can be unclear which time zone should be in effect. Thus, without a clear method of identifying the true and effective time zone, an unattended OTA update may occur at a time that is inconsistent with user intent.

The resolution of different time zones within a geofence may be accomplished by redefining the entire geofenced area to be within a single time zone. In an example, the geofence may be redefined as a circular shape, where the center point of the geofence determines the time zone of the entire geofence, regardless of whether the geofence extends into another time zone. The user may, accordingly, create the geofence by selecting a point on a map and specifying a distance that defines the radius of a circle. In other words, the time zone of the center point is used as the effective time zone of the entire geofence.

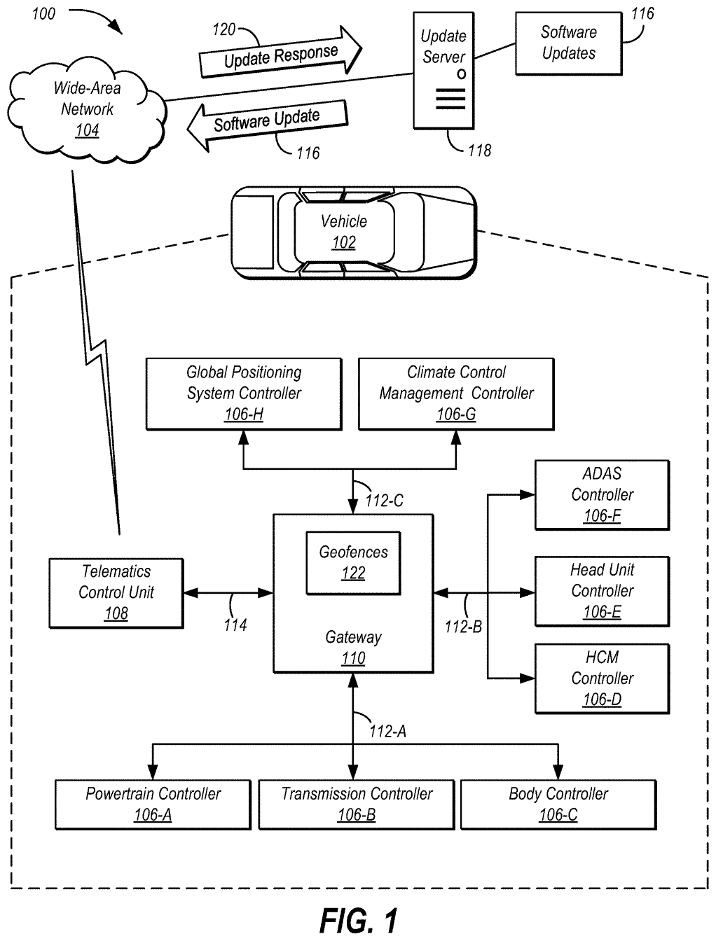

FIG. 1 illustrates an example system 100 including geofences 122 for use in triggering OTA installation of software updates 116. The vehicle 102 includes a plurality of controllers 106, where each is connected to one of a plurality of subnets 112 (as shown subnets 112-A, 112-B and 112-C, each connected to a subset of the controllers 106 (controllers 106-A, 106-B, and 106-C to subnet 112-A, controllers 106-D, 106-E, 106-F connected to subnet 112-B, and controllers 106-G and 106-H connected to subnet 112-C). A telematics control unit (TCU) 108 is included to facilitate communication over a wide-area network 104 between various components of the vehicle 102 and an update server 118 storing software updates 116. The TCU 108 may be connected to a backbone 114 portion of the topology and may communicate with the controllers 106 via a gateway 110. The gateway 110 may be configured to store geofences 122 that may be used to determine when to install the software updates 116 to the controllers 106 of the vehicle 102. While an example system 100 is shown, the example components as illustrated are not intended to be limiting. Indeed, the system 100 may have more or fewer components, and additional or alternative components and/or implementations may be used. As an example, the controllers 106 and the TCU 108 may each be connected to one or more same or different types of nodes as the subnets 112 and the backbone 114.

The vehicle 102 may be of various types, such as, but not limited to, various types of automobile, crossover utility vehicle (CUV), sport utility vehicle (SUV), truck, recreational vehicle (RV), boat, plane or other mobile machine for transporting people or goods. In many cases, the vehicle 102 may be powered by an internal combustion engine. As another possibility, the vehicle 102 may be a hybrid electric vehicle (HEV) powered by both an internal combustion engine and one or more electric motors, such as a series hybrid electric vehicle (SHEV), a parallel hybrid electrical vehicle (PHEV), or a parallel/series hybrid electric vehicle (PSHEV). As the type and configuration of vehicle 102 may vary, the operating characteristics of the vehicle may correspondingly vary. As some other possibilities, vehicle may have different characteristics with respect to passenger capacity, towing ability and capacity, and storage volume.

The wide-area network 104 may include one or more interconnected communication networks such as the Internet, a cable television distribution network, a satellite link network, a local area network, and a telephone network, as some non-limiting examples. By accessing the wide-area network 104, the vehicle 102 may be able to send outgoing data from the vehicle 102 to network destinations on the wide-area network 104 and receive incoming data to the vehicle 102 from network destinations on the wide-area network 104.

The controllers 106 may include various hardware and software components configured to monitor and manage various vehicle functions. The controllers 106 may, accordingly, include one or more processors (e.g., microprocessors) (not shown) configured to execute firmware or software programs stored on one or more storage devices (not shown) of the controllers 106. While the controllers 106 are illustrated as separate components, the vehicle controllers 106 may share physical hardware, firmware, and/or software, such that the functionality from multiple controllers 106 may be integrated into a single controller 106, and the functionality of various such controllers 106 may be distributed across a plurality of controllers 106.

The controllers 106 may include a powertrain controller 106-A configured to manage operating components related to one or more vehicle sources of power, such as engine, battery, and so on, a transmission controller 106-B configured to manage power transfer between vehicle powertrain and wheels, a body controller 106-C configured to manage various power control functions, such as exterior lighting, interior lighting, keyless entry, remote start, and point of access status verification, a headlamp control module (HCM) 106-D configured to control light on/off settings, a head unit controller 106-E configured to drive user interface displays to the user, advanced driver assistance systems (ADAS) 106-F such as adaptive cruise control or automated braking, a climate control management controller 106-G configured to monitor and manage heating and cooling system components (e.g., compressor clutch, blower fan, temperature sensors, etc.), a global positioning system (GPS) controller 106-H configured to provide vehicle location information. It should be noted that these are merely examples and vehicles 102 having more, fewer, or different controllers 106 may be used.

The TCU 108 may include one or more processors (not shown) (e.g., microprocessors) configured to execute firmware or software programs stored on one or more respective storage devices of the TCU 108. The TCU 108 may include a modem or other network hardware to facilitate communication between the vehicle 102 and other devices connected to the wide-area network 104.

The gateway 110 may be configured to facilitate data exchange between vehicle controllers 106. The gateway 110 may be further configured to facilitate data exchange between the vehicle controllers 106 and the TCU 108 located on the backbone 114. In an example, the vehicle controllers 106 and the TCU 108 may communicate with the gateway 110 using CAN communication protocol, such as, but not limited to, a high-speed (HS) CAN, a mid-speed (MS) CAN, or a low-speed (LS) CAN. Different subnets 112 may utilize different CAN protocol speeds. In an example, one or more of the subnets may implement HS-CAN, while one or more other subnets 112 may implement MS-CAN. In yet other examples, the gateway 110 may be configured to facilitate communication using one or more of an Ethernet network, a media-oriented system transfer (MOST) network, a FlexRay network, or a local interconnect network (LIN).

One or more of the subnets 112 may define a main subnet, which may be referred to as a backbone 114. The backbone 114 may include a portion of the topology configured to serve as a joining point of communication for the other subnets 112 of the vehicle 102. Accordingly, the backbone 114 may be configured to manage and route data traffic in a greater volume than that provided via the other subnets 112. Using the message processing features of the gateway 110, the gateway 110 may be configured to transmit message frames between the TCU 108 located on the backbone 114 and the one or more of the vehicle controllers 106 located on the other subnets 112.

The gateway 110 may be configured to identify on which subnet 112 each of the controllers 106 and TCU 108 is located. This may be accomplished according to a corresponding physical network address of the controllers 106 and TCU 108. In an example, in response to receiving a request to route a message to a given controller 106 or the TCU 108, the gateway 110 may query a storage to identify a network address corresponding to the controller 106 or the TCU 108. For instance, the gateway 110 may include a storage configured to store the network addresses, as well as a routing schema defining which messages are routed to which subnets 112 and/or backbone 114. This routing may be determined by the gateway 110 based on predefined parameters included in the message, such as a type of message and/or identifiers of the controllers 106 or the TCU 108 that designate the source and/or target of the message.

The software updates 116 may include software code, configuration settings, and/or data resources to be applied to one or more controllers 106 of the vehicle 102. The update server 118 may include computing hardware configured to provide OTA software update services to the vehicles 102.

The vehicle 102 may provide a configuration of itself to the update server 118. For example, the vehicle 102 may communicate via the wide-area network 104 using queried information about the controllers 106 of the vehicle 102 as well as additional information identifying the specific vehicle 102 (e.g., VIN information published on the CAN bus, subscriber identity module (SIM) information of the TCU 108 such as international mobile station equipment identity (IMEI)). The update server 118 may receive these communications from the vehicle 102 and may maintain a data store of the hardware configurations and software (e.g., firmware) versions linked to identifiers of the vehicle 102.

Based on the vehicle configuration information, the update server 118 may send software updates 116 to the vehicle 102, and/or may provide a trigger or other information to the vehicle 102 to request the vehicle 102 to download the software updates 116. Responsive to the trigger, the TCU 108 may download the software updates 116.

The user of the vehicle 102 may define one or more geofences 122 in which the vehicle 102 must be located in order for the software update 116 to be installed. In an example, the geofence 122 may include a location where the vehicle 102 is parked overnight, such as a home residence of the user.

In some examples, additional criteria may additionally be required to be satisfied in order for installation of the software update 116 to be performed. For instance, a time condition may be required, such that the time is between given hours, e.g., night time when the vehicle 102 is not expected to be used. As another possibility, the vehicle 102 may be required to be off (not in accessory or in a motive mode) and have sufficient battery reserves to complete the installation of the software update 116. Upon satisfaction of the criteria, the software update 116 may be installed. Responsive to installation of the software update 116, the vehicle 102 may send an update response 120 to the update server 118. The update response 120 may indicate whether installation of the software update 116 was successful.

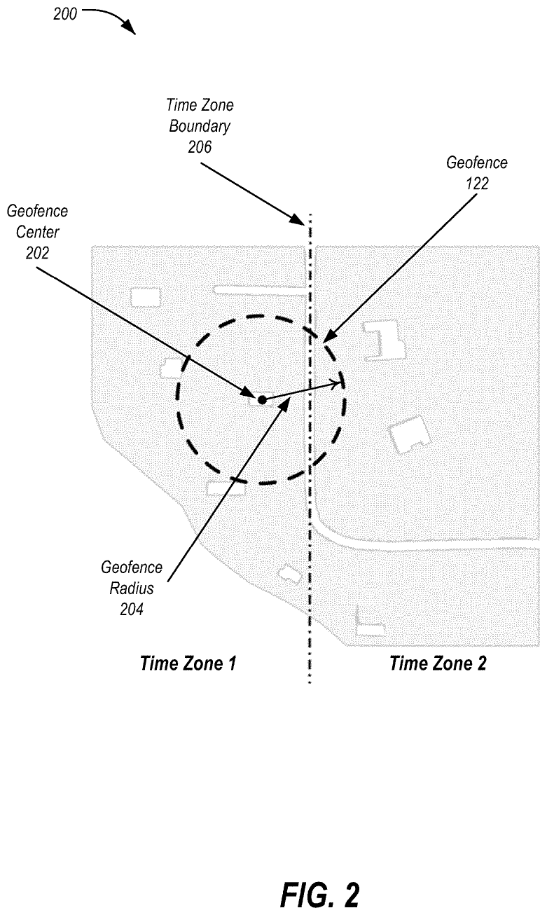

FIG. 2 illustrates an example diagram 200 of a geofence 122 that includes area within multiple time zones. The example geofence 122 is defined in the example diagram 200 as a geofence center 202 and a radius 204, although other ways of defining a geofence 122 are possible, such as via a path, a route along roadways, a zip code, a city boundary, a state boundary, or a rectangle. As shown, the geofence 122 is mostly within time zone 1, but also has a portion that crosses over a time zone boundary 206 into time zone 2.

The geofence 122 may specify that a software update 116 is to be performed at midnight. However, because a portion of the geofence 122 extends into another time zone, that update may instead occur one hour off from the requested time. This behavior may lead to user confusion and frustration. However, by redefining the geofence 122 such that the entire included area of the geofence 122 is deemed to be within the same time zone, the software update 116 may be installed at a single time, regardless of whether the geofence 122 extends into another time zone.

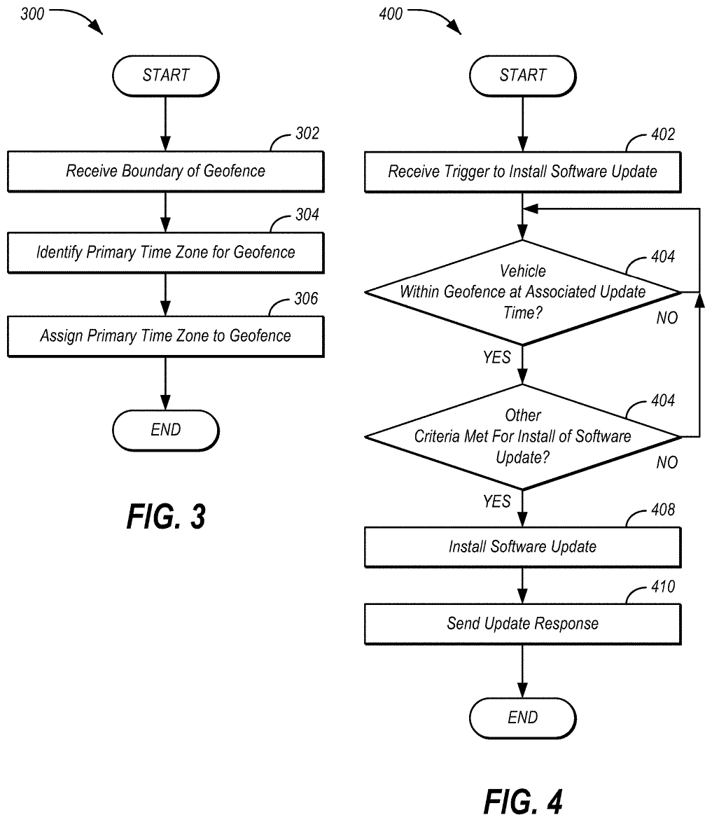

FIG. 3 illustrates an example process 300 for assigning a geofence 122 to a single time zone. In an example, the process 300 may be performed by the system 100 discussed in detail above. For instance, the process 300 may be initiated at operation 302 responsive to receipt by the vehicle 102 of a definition of a geofence 122. In an example, a user of the vehicle 102 may enter the bounds of the geofence 122 into a user interface of the vehicle 102. In another example, the bounds of the geofence 122 may be received by the vehicle 102 over the wide-area network 104, e.g., from the update server 118. In yet another example, the bounds of the geofence 122 may be received by the vehicle 102 from a smartphone or other mobile device that is paired with and connected to the vehicle 102, such as the mobile device of a user of the vehicle 102.

At 304, the vehicle 102 identifies a primary time zone for the geofence 122. The primary time zone may indicate the time zone that all locations within the geofence 122 are deemed to be within, regardless of whether the geofence 122 extends across multiple time zones. In an example, the vehicle 102 may identify the primary time zone of the geofence 122 as the geographic center of the geofence 122, e.g., the geofence center 202 as shown in the diagram 200. In another example, the vehicle 102 may identify the primary time zone of the geofence 122 as the time zone in which a greatest amount of the area of the geofence 122 is located. In yet a further example, the vehicle 102 may receive input from a user indicating the primary time zone of the geofence 122, e.g., via the vehicle 102 human-machine interface (HMI) responsive to the vehicle 102 requesting the user to indicate the primary time zone of the geofence 122. As an even further example, the vehicle 102 may identify one or more points of interest located within the geofence 122, e.g., the user's home, the user's work, or other location that the user of the vehicle 102 frequents and may identify the primary time zone of the geofence 122 as the time zone of the point of interest.

At 306, the vehicle 102 assigns the primary time zone to the geofence 122. In an example, the vehicle 102 stores the time zone identified in operation 304 as the time zone to use to determine whether software updates are triggered by vehicle 102 presence within the geofence 122. In an example, this information may be stored to the TCU 108. After operation 306, the process 300 ends.

FIG. 4 illustrates an example process 400 for using a geofence 122 to trigger OTA installation of a software update 116. In an example, and similar to the process 300, the process 400 may be performed by the system 100 discussed in detail above.

At operation 402, the vehicle 102 receives a trigger for installation of a software update 116. In an example, the trigger may be received from the update server 118. As one possibility, the vehicle 102 may provide a configuration of itself to the update server 118 and may receive the trigger in response. Responsive to the trigger, the vehicle 102 may download the software update 116, or may note to download the software update 116, e.g., from the update server 118 or from another location.

At 404, the vehicle 102 determines whether the vehicle 102 is within a geofence 122 at an associated update time. In an example, the vehicle 102 may utilize the global positioning system controller 106-H to identify a current position of the vehicle 102. In another example, the vehicle 102 may utilize a last-known position of the vehicle 102 that was saved when the vehicle 102 was last stopped or parked. The vehicle 102 may compare this location with the geofence 122 to determine whether the vehicle 102 is located within the geofence 122. If not, the control remains at operation 404.

If so, then the vehicle 102 may further confirm whether the current time is within the times allowed for installation of software updates 116. In an example, the geofence 122 may be associated with a time window or time period or specific time during which software updates may be installed, and the vehicle 102 may confirm that the current time meets within those allowable times. Additionally or alternately, the vehicle 102 may specify a time window or time period or specific time during which software updates may be installed, and the current time may be compared with that time. Notably, the current time may be determined as the current time of the primary time zone assigned to the geofence 122, not of the current time of the actual location of the vehicle 102. If the current time is within the times allowed for installation of software updates 116, control passes to operation 406. Otherwise, control remains at operation 404.

At 406, the vehicle 102 determine whether other criteria are met to install the software update 116. In an example, the vehicle 102 may confirm that the vehicle 102 is off, e.g., not in an accessory or motive mode. In another example, the vehicle 102 may confirm that the vehicle 102 has sufficient battery reserves to complete the installation of the software update 116. For instance, the vehicle 102 may confirm that installation of the software update 116 will still allow the vehicle 102 battery to have a state of charge above a predefined threshold value, e.g., sufficient power for the vehicle 102 to be restarted.

At 408, the vehicle 102 installs the software update 116. In an example, the gateway 110 may send the software update 116 to the controller 106 of the vehicle 102 that is to install the software update 116. The controller 106 may, in turn, install the update, and send a notification to the gateway 110 that the installation was completed.

The vehicle 102 sends the update response 120 at operation 410. In an example, the vehicle 102 may send the update response 120 to the update server 118. After operation 410, the process 400 ends.

Computing devices described herein, such as the controllers 106, TCU 108, and update server 118, generally include computer-executable instructions where the instructions may be executable by one or more computing devices such as those listed above. Computer-executable instructions may be compiled or interpreted from computer programs created using a variety of programming languages and/or technologies, including, without limitation, and either alone or in combination, JAVA™, C, C++, C#, VISUAL BASIC, JAVASCRIPT, PYTHON, JAVASCRIPT, PERL, PL/SQL, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A system comprising:
a processor of a vehicle programmed to
receive a boundary of a geofence, the geofence spanning a plurality of time zones;
identify a primary time zone as one of the plurality of time zones of the geofence;
assign the primary time zone to the geofence; and
initiate installation of a software update to the vehicle responsive to the vehicle being located within the geofence and a current time being within a period of time for software updates, the current time being determined according to the primary time zone of the geofence, regardless of a time zone of a current location of the vehicle.

2. The system of claim 1, wherein the processor is further programmed to identify the primary time zone of the geofence is as a time zone of a geographic center point of the geofence.

3. The system of claim 1, wherein the processor is further programmed to identify the primary time zone of the geofence is as a time zone of a point of interest within the geofence that is frequented by the vehicle.

4. The system of claim 1, wherein the processor is further programmed to identify the primary time zone of the geofence is as a time zone of a majority of area included within the geofence.

5. The system of claim 1, wherein the processor is further programmed to identify the primary time zone of the geofence is as a time zone specified by a user of the vehicle.

6. (canceled)

7. A method comprising:
receiving, by a vehicle, a boundary of a geofence spanning a plurality of time zones;
identifying a primary time zone as one of the plurality of time zones of the geofence; and
initiating installation of a software update responsive to the vehicle being located within the geofence and a current time within the primary time zone being within a period of time for software updates.

8. The method of claim 7, further comprising identifying the primary time zone of the geofence as a time zone of a geographic center point of the geofence.

9. The method of claim 7, further comprising identifying the primary time zone of the geofence as a point of interest within the geofence that is frequented by the vehicle.

10. The method of claim 7, further comprising identifying the primary time zone of the geofence as a time zone of a majority of area included within the geofence.

11. The method of claim 7, further comprising identifying the primary time zone of the geofence as a time zone specified by a user of the vehicle.

12. A non-transitory computer-readable medium comprising instructions that, when executed by a processor of a gateway of a vehicle, causes the gateway to:
receive a boundary of a geofence spanning a plurality of time zones;
identify a primary time zone as one of the plurality of time zones of the geofence; and
initiate installation of a software update responsive to the vehicle being located within the geofence and a current time within the primary time zone being within a period of time for software updates.

13. The medium of claim 12, further comprising instructions that, when executed by the gateway, cause the gateway to identify the primary time zone of the geofence as a time zone of a geographic center point of the geofence.

14. The medium of claim 12, further comprising instructions that, when executed by the gateway, cause the gateway to identify the primary time zone of the geofence as a point of interest within the geofence that is frequented by the vehicle.

15. The medium of claim 12, further comprising instructions that, when executed by the gateway, cause the gateway to identify the primary time zone of the geofence as a time zone of a majority of area included within the geofence.

16. The medium of claim 12, further comprising instructions that, when executed by the gateway, cause the gateway to identify the primary time zone of the geofence as a time zone specified by a user of the vehicle.
